(19) United States
(12) Patent Application Publication
(10) Pub. No.: US 2007/0098864 A1
(43) Pub. Date: May 3, 2007

(54) PROCESS FOR PREPARING FORMULATIONS OF LYPOPHILIC ACTIVE SUBSTANCES BY SPRAY FREEZING DRYING

(76) Inventors: Gerrit S. Zijlstra, Weesp (NL); Bastiaan H.J. Dickhoff, Weesp (NL); Dirk J. Van Drooge, Weesp (NL); Wouter L.J. Hinrichs, Weesp (NL); Henderik W. Frijlink, Weesp (NL)

Correspondence Address: MAYER, BROWN, ROWE & MAW LLP, P.O. BOX 2828, CHICAGO, IL, 60690-2828, US

(21) Appl. No.: 11/456,438

(22) Filed: Jul. 10, 2006

Related U.S. Application Data
(63) Continuation of application No. 11/269,954, filed on Nov. 9, 2005, now abandoned.
(60) Provisional application No. 60/627,002, filed on Nov. 10, 2004.

(51) Int. Cl. A23L 1/236

(52) U.S. Cl. 426/548

(57) ABSTRACT

In one embodiment, the present invention relates to methods for the preparation of pharmaceutical compositions comprising a lipophilic compound and a glass of a sugar, a sugar alcohol, a mixture of sugars and/or a mixture of sugars alcohols. The invention is further related to such pharmaceutical compositions and the use of such compositions in the treatment of various diseases and disorders.

This application claims priority to U.S. Provisional Patent Application Ser. No. 60/627,002 filed on Nov. 10, 2004, the entirety of which is incorporated by reference herein.

### FIELD OF THE INVENTION

In various embodiments, the present invention relates to processes for preparing pharmaceutical compositions by spray freeze drying a lypophilic active substance, and to compositions prepared by such processes.

### BACKGROUND OF THE INVENTION

International Patent Publication WO 03/082246 describes the use of a stable sugar based solid dispersion of a lypophilic substance that can be obtained by freeze drying, for example from a mixture obtained by mixing a solution of the sugar in water with a solution of the lypophilic substance in an organic solvent miscible with water.

Unfortunately, the process described in WO03/082246, while overcoming some technical problems, still has drawbacks. For example, the process cannot be scaled up easily making commercial application difficult. Moreover, WO03/082246 discloses a spray drying technique that is not believed to result in a true and complete solid dispersion, but rather one that is believed to result in a phase separated product. This, in turn, is believed to lead to undesirable decomposition of the product during storage.

If one or more of the above and other drawbacks could be overcome, a significant advance in the art would be realized.

### SUMMARY OF THE INVENTION

In one embodiment, the present invention provides a method for the preparation of a pharmaceutical composition comprising a lipophilic compound and a glass of a sugar, a sugar alcohol, a mixture of sugars and/or a mixture of sugar alcohols, wherein the lipophilic compound is incorporated in the glass.

In another embodiment, the process comprises the steps of: (a) dissolving a lipophilic compound in an organic solvent that is miscible with water to form a first solution; (b) dissolving a sugar, sugar alcohol, mixture of sugars and/or sugar alcohols in water to form a second solution; (c) mixing the first and second solutions together in such a manner that a substantially homogeneous mixture is obtained; and (d) spray freeze drying the mixture. In one embodiment, the spray freeze drying step (d) is performed immediately after step (c). In another embodiment, step (d) is initiated and/or completed prior to phase separation occurring in the mixture resulting from step (c).

Compositions prepared by such a process and methods of using such compositions represent further embodiments of the present invention.

### BRIEF DESCRIPTION OF THE DRAWINGS

FIG. 1 shows SEM pictures of different compositions shown in Table I.

FIG. 2 shows median volume diameters of spray freeze dried powder, determined by laser diffraction, with RODOS dispersion at 0.5 bar (shaded bars) and with test inhaler dispersion at 60 L/min for 3 seconds (open bars).

FIG. 3 shows THC content as a function of storage time in spray freeze dried powders with 4% and 8% weight THC and in pure THC samples.

FIG. 4 shows stability of THC in solid dispersions as a function of drug load.

FIG. 5 shows the long term stability of THC under ambient conditions.

FIG. 6 shows the fine particle fraction for various THC-containing powders.

FIG. 7 shows thermograms of solid dispersions and physical mixture containing diazepam and inulin.

FIG. 8 shows dissolution rates of 5 drugload batches of composition comprising cyclosporin A and inulin.

### DETAILED DESCRIPTION OF THE INVENTION

While the present invention is capable of being embodied in various forms, the description below of several embodiments is made with the understanding that the present disclosure is to be considered as an exemplification of the invention, and is not intended to limit the invention to the specific embodiments illustrated. Headings are provided for convenience only and are not to be construed to limit the invention in any way. Embodiments illustrated under any heading may be combined with embodiments illustrated under any other heading.

The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. As used herein, the terms “about” and “approximately” when referring to a numerical value shall have their plain and ordinary meanings to one skilled in the art of pharmaceutical sciences or the art relevant to the range or element at issue. The amount of broadening from the strict numerical boundary depends upon many factors. For example, some of the factors to be considered may include the criticality of the element and/or the effect a given amount of variation will have on the performance of the claimed subject matter, as well as other considerations known to those of skill in the art. Thus, as a general matter, “about” or “approximately” broaden the numerical value. For example, in some cases, “about” or “approximately” may mean ±5%, or ±10%, or ±20%, or ±30% depending on the relevant technology. As used herein, the use of differing amounts of significant digits for different numerical values is not meant to limit how the use of the words “about” or “approximately” will serve to broaden a particular numerical value. Also, the disclosure of ranges is intended as a continuous range including every value between the minimum and maximum values.

In the context of the present invention the expression “lipophilic active compound” or “lipophilic compound” refers to an active compound having a solubility in water not greater than about 1 mg/ml. The invention is also useful for active compounds having a solubility in water not greater than about 0.5 mg/ml or not greater than about 0.1 mg/ml. Examples of lipophilic active compounds are Δ⁹-tetrahydro-cannabinol, diazepam and cyclosporin A.

In one embodiment, the present invention provides a process for the preparation of a pharmaceutical composition comprising a lipophilic compound and a glass of a sugar, a sugar alcohol, a mixture of sugars and/or a mixture of sugar alcohols, wherein the lipophilic compound is incorporated in the glass of the sugar, sugar alcohol, mixture of sugars and/or mixture of sugar alcohols.

In another,embodiment, the above process comprises the steps of: (a) dissolving a lipophilic compound in an organic solvent that is miscible with water to form a first solution, (b) dissolving a sugar, sugar alcohol, mixture of sugars and/or sugar alcohols in water to form a second solution; (c) mixing the first and second solutions together in such a way that a substantially homogeneous mixture is obtained; and (d) spray freeze drying the mixture. Steps (a) and (b) can be performed in any order or substantially simultaneously. In one embodiment, step (d) is performed immediately after step (c) is completed. In another embodiment, step (d) is initiated and/or completed within 60, 30, 20, 10, 9, 8, 7, 6, 5, 4, 3, 2 or 1 minute(s) after completion of step (c). In another embodiment, step (d) is initiated and/or completed prior to phase separation occurring in the mixture resulting from step (c).

In one embodiment, during step (c), the first and second solutions are mixed at a volume ratio of about 2:10 to about 10:2, about 3:8 to about 8:3, or about 4:6 to about 6:4.

The term “spray freeze drying” as used herein refers to a technique of spraying (aerosolizing) small droplets of li33quid material into cold (e.g. below or well below the Tg) gas (e.g. air) or a cold fluid (e.g. liquid nitrogen). Illustrative temperatures for the gas are below about 35° C., below about 20° C., below about 0° C., below about −50° C., below about −75° C., below about −100° C., below about −150° C., or below about −200° C. Nitrogen is in liquid form under normal atmospheric pressure from about −196° C. to about −210° C. The droplet size of the spray or aerosol depends on different factors such as the intended use of the particles and the amount of solid material in the solution. In general, the size of the aerosol droplets will be about 1 μm to about 5000 μm, about 1 μm to about 1000 μm or about 5 μm to about 500 μm, for example about 20, about 40, about 60, about 80, about 100, about 120, about 140, about 160, about 180, about 200, about 220, about 240, about 260, about 280, about 300, about 320, about 340, about 360, about 380, about 400, about 420, about 440, about 460, about 480 or about 500 μm. With this freeze drying technique, large volumes of the solution can be frozen and further freeze dried to form a powder. Moreover, high concentrations of the solutes can be applied, provided the spraying step is performed soon enough after the mixing step (c) is completed to prevent phase separation after mixing of the solutions.

Spray freezing technology is known from the prior art. Y—F Maa and S. J. Prestrelski (Current Pharmaceutical Biotechnology 2000, 1, 283-302) and Y—F Maa et al., Pharm. Res. 1999, 16, 249-54, each hereby incorporated by reference herein, describe the use of different powder production techniques for biopharmaceutical powders such as protein/peptide based drug formulations.

In one embodiment, the first and second solutions are mixed continuously or semi-continuously prior to, and optionally immediately prior to, the spray freeze drying step. Illustratively, the spray freeze drying step comprises spraying the mixture of first and second solutions to form droplets. The phrase “semi-continuously” in the present context means that while the two solutions are made batch wise, the mixing and spray drying steps take place substantially continuously until the solutions are fully used. In one embodiment, the time between mixing and initiation of the spray freeze drying step is illustratively not greater than about 15 minutes, not greater than about 10 minutes, or not greater than about 5 minutes. In another embodiment, the spray freeze drying step is initiated immediately after the mixing step occurs, so that the two steps occur semi-continuously. In another embodiment, the spray freeze drying step and mixing steps are performed continuously. In another embodiment, the spray freeze drying step is initiated as the first and second solutions are being mixed.

In another embodiment, the spray freeze drying step is initiated before the phase separation has reached about 30%, about 25%, about 20%, about 15%, about 10% or about 5%.

In one embodiment, the spray freeze drying step employes a feed rate of about 7 to about 20 ml/min, about 8 to about 18 ml/min, about 9 to about 17 ml/min or about 10 to about 15 ml/min.

In one embodiment, the dry substance content of the mixture just before the spray freeze drying step is not less than 5%, not less than 8%, or not less than 10%, by weight. In another embodiment, the content of the active substance in the mixture just before spray freeze drying is not less than 0.5%, not less than 1.0%, not less than 2.0%, or not less than 4.0% or greater, for example about 0.5% to about 80%, about 1% to about 60%, or about 2% to about 50%, by weight.

For the spray freeze drying process, any suitable apparatus can be used, for example the apparatus described in U.S. Pat. No. 5,922,253, which is hereby incorporated by reference herein in its entirety.

In the context of the present invention, the term “sugar” includes polysugars and the term “sugar alcohols” includes poly sugar alcohols. In one embodiment, the sugar glass formed has a glass transition temperature of not less than about 40° C., not less than about 45° C., not less than about 50° C., not less than about 55° C., or not less than about 60° C. at normal environmental conditions, for example about 40° C. to about 100° C., about 45° C. to about 95° C., or about 50° C. to about 90° C. Illustrative sugars for use in accordance with the present invention are non-reducing sugars. A non-reducing sugar is a sugar that does not have or can not form reactive aldehyde or ketone groups. Examples of non-reducing sugars are trehalose and fructanes such as inulines.

Illustrative non-reducing sugars for use in various embodiments of the present invention include fructans or mixtures of fructans. A fructan is understood to mean any oligo- or polysaccharide which contains a plurality (i.e. more than 1) of anhydrofructan units. The fructans can have a polydisperse chain length distribution, and can have a straight or branched chain. Illustratively, the fructans can contain mainly β-1,2 bonds, as in inulin, or they can also contain β-2,6 bonds, as in levan. Suitable fructans can originate directly from a natural source, but may also have undergone modification or may be synthesized.

Illustrative modifications are reactions known per se that lead to a lengthening or shortening of the chain length. In addition to naturally occurring polysaccharides, also industrially prepared polysaccharides, such as hydrolysis products which have shortened chains and fractionated products having a modified chain length are also suitable in the present invention. A hydrolysis reaction to obtain a fructan having a reduced chain length can be carried out enzymatically (for instance with endoinulase), chemically (for instance with aqueous acid, physically (for instance thermally) or by the use of heterogeneous catalysis (for instance with an acid ion exchanger).

Fractionation of fructans, such as inulin, can be achieved in any suitable manner, for example through crystallization at low temperature, separation with column chromatography, membrane filtration and selective precipitation with an alcohol. Other fructans, such as long-chain fructans, can be obtained in any suitable manner, for instance through crystallization, from fructans from which mono-and disaccharides have been removed. Fructans whose chain length has been enzymatically extended can also serve as a fructan in the present invention. Further, reduced fructans can be used, which are fructans whose reducing end groups, normally fructose groups, have been reduced, for instance with sodium borohydride, or hydrogen in the presence of a transition metal catalysts.

Fructans which have been chemically modified, such as crosslinked fructans and hydroxyalkylated fructans, can also be used. The average chain length in all these fructans is expressed as the number-average degree of polymerization (DP). The abbreviation DP is defined as the average number of sugar units in the oligo- or polymer.

Other reducing sugars suitable for use in the present invention include inulins or mixtures of inulins. Inulins are oligo- and polysaccharides, consisting of β-1,2 bound fructose units with an α-D-glucopyranose unit at the reducing end of the molecule and are available with different degrees of polymerization (DP). In one embodiment, suitable reducing sugars are inulins with a DP of at least about 6 or a mixture of inulins wherein each inulin has a DP of at least about 6.

In another embodiment, suitable reducing sugars are inulins or mixtures of inulins with a DP of about 10 to about 30 or about 15 to about 25, for example about 10, about 11, about 12, about 13, about 14, about 15, about 16, about 17, about 18, about 19, about 20, about 21, about 22, about 23, about 24, about 25, about 26, about 27, about 28 about 29 or about 30. Inulins occur inter alia in the roots and tubers of plants of the Liliaceae and Compositae families. Illustrative sources for the production of inulin are the Jerusalem artichoke, the dahlia and the chicory root. Industrial production starts mainly from the chicory root. The main difference between inulins originating from the different natural sources resides in the degree of polymerization (DP), which can vary from about 6 in Jerusalem artichokes to about 10 to about 14 in chicory roots and, to 20 or more in the dahlia. Inulin is an oligo- or polysaccharide which in amorphous condition has favorable physicochemical properties for the application as auxiliary substance in pharmaceutical formulations. These physicochemical properties are: (adjustable) high glass transition temperature, no reducing aldehyde groups and normally a low rate of crystallization. Further inulin is non toxic and inexpensive.

In one embodiment of compositions of the invention, the weight ratio of lipophilic compound to sugar or sugar alcohol (or mixture thereof) is typically in the range of about 1:1 to about 1:200, about 1:10 to about 1:50, or about 1:12 to about 1:25.

Organic solvents which are suitable to form a mixture that is stable for a sufficient amount of time with the sugar, water and the lipophilic compound are solvents which are mixable with water such as dimethylsulfoxide (DMSO), N,N-dimethylformamide (DMF), acetonitrile, ethylacetate, 1,4-dioxane and lower alcohols. As the solvents have to be removed by spray drying or freeze drying, in one embodiment, the solvents also have a reasonable vapor pressure at the desired drying temperature. In one embodiment, the solvent comprises a lower 1,4 dioxane and/or alcohols, defined as C₁-C₆ alcohols, wherein the alkyl chain is branched or unbranched. In another embodiment, the solvent is a C₂-C₄ alcohols such as ethanol, n-propyl alcohol and t-butyl alcohol.

Any suitable lypophilic compound can be used in accordance with the present invention. Illustrative compounds include cannabinoid compounds or natural cannabinoid copounds. The term “natural cannabinoid compound” includes non-natural derivatives of cannabinoids which can be obtained by derivatization of natural cannabinoids and which are unstable like natural cannabinoids. One suitable cannabinoid compound is Δ⁹-tetrahydro-cannabinol. Uses of such compounds are well known in the art.

In another embodiment, the present invention provides pharmaceutical composition comprising a lipophilic compound and a glass of a sugar, a sugar alcohol, a mixture of sugars and/or a mixture of sugar alcohols, obtained by spray freeze drying, wherein the lipohilic compound is incorporated in the sugar glass, characterized in that said composition comprises spherical particles having a mean geometric particle size of about 6 to about 5000 μm, about 6 to about 500 μm, or about 8 to about 25 μm, and optionally a span not greater than about 6, about 5, about 4 or about 3. The term “spherical” herein means that the outer perimeter of the particle has no sharp edges and the aspect ratio of the two dimensional projection is over about 0.6. (see A. M. Bouwman et al, Powder Technology 2004,146, 66-72 and P. Schneiderhöhn, A comparative study on methods for quantitative determination of rounding and shape using grains of sand, Heidelberger contributions to mineralogy and petrography 1954, 4, 82-85.). In one embodiment, no guest-host complex is formed between the lipophilic compound on the one hand and the sugar, sugar alcohol, mixture of sugars and/or mixture of sugar alcohols on the other hand.

In one embodiment, particles obtained by the processes described herein have a porosity of about 70% or greater, about 80% or greater, about 85% or greater, or about 90% or greater. In another embodiment, the particles obtained have a specific surface not less than about 40 m²/g, not less than about 80 m²/g, or not less than about 100 m²/g, for example about 40 m²/g to about 1000 m²/g, about 40 m²/g to about 700 m²/g, about 40 m²/g to about 500 m²/g, or about 40 m²/g to about 400 m²/g.

Another embodiment of the present invention relates to a pharmaceutical composition comprising a lipophilic compound and a glass of a sugar, a sugar alcohol, a mixture of sugars and/or a mixture of sugar alcohols, obtained by spray freeze drying, wherein the lipohilic compound is incorporated in the sugar glass, characterized in that said composition comprises spherical particles having a mean aerodynamic particle size of about 1 to about 20 μm, about 1 to about 10 μm, or about 1 to about 5 μm, and a span not greater than about 6, about 5 or about 4, for example about 1 to about 6, about 2 to about 5, or about 4 to about 4.

In another embodiment, particles having the above particle size are directly obtained by the spray freeze drying process, without any particle size reduction step, such as milling. The product according to one embodiment of the present invention comprise an amount of degradation product not greater than about 10% and a percentage of phase separation not greater than about 15%. In one embodiment, in standard dissolution tests using aqueous dissolution media, that guarantee sink conditions, the material dissolves within about 120 minutes, within about 100 minutes, within about 80 minutes, within about 60 minutes, within about 45 minutes, within about 30 minutes, or within about 25 minutes. In another embodiment, the physical properties of the particles (e.g. aerodynamic particle size distribution, shape and the fragility of the particles) make the product especially suitable for dispersion into an aerosol that can be used for pulmonary administration. When the particle size is reduced due to breakage during dispersion, this increases the chance for peripheral lung deposition.

In one embodiment, particles obtained by processes described herein, upon storage at 20° C./45% RH for a period of about 50, about 60, about 70, about 80, about 90, about 100, about 150, about 200, about 250, about 300 or about 350 days, exhibit at least about 40%, about 50%, about 60%, about 70%, about 80% or about 90% of the original lypophilic compound (e.g. THC) in non-degraded form.

In another embodiment, particles obtained by processes described herein, upon storage at 60° C./8% RH for a period of about 20, about 30, about 40, about 50, about 60, about 70, about 80, about 90, about 100, or about 150 days, exhibit at least about 15%, about 20%, about 30%, about 40%, about 50%, about 60%, about 70% or about 80% of the original lypophilic compound (e.g. THC) in non-degraded form.

It has surprisingly been found that spray freeze drying of a lipophilic compound from a mixture of a sugar solution in water and a solution of the lipophilic compound in an organic solvent miscible with water, yielding a sugar glass, can be performed on a large scale leading to a product having desired properties and even one or more superior properties compared with the product obtained according to the freeze drying method disclosed in WO03/082246, such as better stability, an optimal aerodynamic particle size and aerodynamic particle size distribution for pulmonary administration without any particle size reduction, easier de-agglomeration when used for pulmonary administration.

In one embodiment, a process of the invention is performed on a large scale. In another embodiment, a process of the invention is performed on a commercial scale. The phrase “commercial scale” herein refers to a process that results in an a mount of finished product (e.g. formulation), by weight, of about 50 kg or more, about 100 kg or more, about 1000 kg or more, or about 5000 kg or more, for example about 50 kg to about 20,000 kg, about 100 kg to about 15,000 kg, about 200 kg to about 10,000 kg or about 500 kg to about 5000 kg. In one embodiment, a commercial scale process is one that results in substantially all product desired for a commercial manufacturing campaign.

### EXAMPLES

The following examples are only intended to further illustrate the invention, in more detail, and therefore these examples are not deemed to restrict the scope of the invention in any way.

### Example 1

### Materials and Methods

### Example 1a

### Materials

The following materials were of analytical grade and used as supplied: methanol, ethanol and tertiary butanol (TBA). Inulin, type TEX803!, having a number average degree of polymerization (DP) of 23, was provided by Sensus, Roosendaal, The Netherlands. Δ⁹-tetrahydrocannabinol was a gift of Unimed Pharmaceuticals Inc., Marietta, USA. Demineralized water was used in all cases. Diazepam was obtained from Sigma-Aldrich Chemie GmbH, Steinheim, Germany. Cyclosporin A was obtained from Bufa B. V., Uitgeest, The Netherlands.

### Example 1b

### Methods

Dissolution Experiments

Dissolution experiments were carried out in triplicate in a 0.25% SDS (w/v) solution using an USP dissolution apparatus I (basket).

Determination of Porosity After Spray Freeze Drying

The porosity (ε) after spray freeze drying was measured according to the following procedure. Inulin was dissolved in water/TBA mixtures of 6/4 v/v. The inulin concentration (c) was varied from 13.3 mg/ml up to 100 mg/ml. These solutions were slowly pumped through a tube to generate equally sized droplets. The volume of the generated droplets (V_{drop}) was determined by counting the number of drops necessary to fill a volume of 5.00 ml. The droplets were frozen by dropping them into a bucket filled with liquid nitrogen. The frozen solution spheres were photographed by a digital camera together with a ruler for calibration. Sigma Scan Pro 5.0 (Jandel Scientific, Erkrath, Germany) was used to determine the cross sectional area of the frozen droplets. Subsequently, the diameter was calculated. The diameter of the spray freeze dried particles (dₚ) was determined according to the same procedure. The porosity was calculated with the following equation:

$$ɛ = \frac{\frac{1}{6} π {d}_{p}^{3} - \frac{{V}_{drop} c}{{ρ}_{inulin}}}{\frac{1}{6} π {d}_{p}^{3}}$$

For the density of inulin, ρᵢₙᵤₗᵢₙ, 1.534 g/cm³ was taken (H. J. C. Eriksson et al., Int. J. Pharm. 2002, 249, 59-70).

Scanning Electron Microscopy (SEM)

Double sided adhesive tape was placed on an aluminium specimen holder upon which a small amount of powder was deposited. The particles were coated with approximately 10-20 nm gold/palladium, using a sputter coater (Balzer A G, type 120B, Balzers, Liechtenstein). Scans were performed using a JEOL scanning electron microscope (JEOL, type JSM-6301F, Japan) at an acceleration voltage of 1.5 kV. All micrographs were taken at a magnification of 2000.

Laser Diffraction

The geometric particle size distribution was measured with a Sympatec HELOS compact KA laser diffraction apparatus (Sympatec GmbH, Clausthal-Zellerfeld, Germany). The powder was dispersed using a RODOS dry powder dispenser at 0.5 bar or using an inhaler adapter (INHALER, Sympatec GmbH, Clausthal-Zellerfeld, Germany) in combination with a test inhaler based on air classifier technology at 60 L/min for 3 seconds (A. H. de Boer et al. Int. J. Pharm. 2002, 249, 233-245; A. H. de Boer et al., Int. J. Pharm. 2003, 260, 187-200). A 100 mm lens was used and calculations were based on the Fraunhofer theory. All data given are the mean of at least four measurements.

Differential Scanning Calorimetry

Thermal behaviour of the spray freeze dried powders was determined by modulated differential scanning calorimetry (MDSC) on a differential scanning calorimeter (DSC2920, TA Instruments, Gent, Belgium). A modulation amplitude of 0.318° C., a modulation period of 60 seconds and a heating rate of 2° C./min was used. Calibration was performed with indium. Standard aluminium sample pans were used. During measurement, the sample cell was purged with nitrogen at a flow rate of 35 mL/min. Before scanning, the sample pan was heated at 2° C./min to 50° C. to remove all residual moisture. Subsequently, the sample was cooled to −20° C. and then scanned up to 180° C. The glass transition temperature (Tg) was defined as the inflection point of the change in specific heat in the reversing signal.

BET Analysis

A 5-point nitrogen adsorption isotherm at 77 K was measured with a Tristar surface analyser Micromeritics Instrument Corporation, Norcross (Ga.), USA. The BET theory (S. Brunauer et al., J. Am. Chem. Soc. 1938, 60, 309-319) was used to calculate the surface area. Duplicate analyses were performed with all spray freeze dried powders taken from a vacuum desiccator. For every drug load two different batches were analysed.

Stability Study

To investigate the degradation of pure THC, 20 mL glass vials were charged with 70 μL of a solution of THC in methanol containing 2.52 mg THC. They were left overnight under a flow of dry nitrogen to allow for methanol evaporation. The resulting thin layers of THC spread over the bottom of the vials (4.5 cm²). Spray freeze dried and freeze dried material containing THC were weighed in vials. All samples were stored in climate chambers of 20° C./45% RH and 60° C./8% RH. Samples (n=3) were taken at different time intervals and analysed by means of HPLC using the method described by van Drooge et al. (Eur. J. Pharm. Sci. 2004, 21, 511-518). Briefly, samples were extracted with methanol. A Waters 717+ autosampler was used to inject 50 μL of supernatant on a precolumn (HPLC precolum inserts, μBondapak C18 Guardpak) followed by a Chrompack Nucleosil 100 C18 column (4.6×250 mm). Absorbance at 214 nm was measured with a UV detector (Shimadzu SPD-M6A). Chromatograms and peak areas were analysed with an integrator (waters 741 Data Module) and Kromasystem 2000 software. The flow rate of the eluens (methanol/water 92/8 (v/v) plus 5 drops concentrated sulphuric acid per litre eluens) was set at 1.0 mL/min. In a chromatogram of untreated THC, a large peak was observed at a retention time of 7.5 min. In every series of HPLC-runs some calibration samples were included.

Cascade Impactor Analysis

In vitro deposition of the powder formulations was tested with a multi-stage liquid impinger (MSLI) of the Astra type (Erweka, Heusenstamm, Germany). A flow rate of 60 L/min was used for 3 seconds according to the procedure described by the European Pharmacopeia 4^{th} Ed. 2002. A mixture of water and ethanol (90% v/v water) was used as solvent since the use of pure water resulted in inhomogeneous solutions and improper rinsing due to the low aqueous solubility of THC. Each impactor stage was filled with 20 mL of solvent. In the final stage a dry glass filter (Gelman Sciences, type A/E, Michigan, USA) was used for the retention of particles that passed the fourth stage. A previously described test inhaler based on air classifier technology (A. H. de Boer et al. Int. J. Pharm. 2003, 260, 187-200) was used under controlled ambient conditions (20° C./50% RH) and in each experiment 10 inhalations were performed. All powders used were pre-equilibrated in a climate chamber at 20° C. and 45% RH. Two independently produced spray freeze dried batches were analysed. The deposition was defined as the weight fraction powder relative to weight of the powder used in the cascade impactor analysis and was calculated from the drug load and the inulin concentration. The inulin concentration on each of the different stages was analysed using the Anthrone assay (T. A. J. Scott et al. Analytical Chemistry 1953, 25, 1656-1661). Samples of 1.00 mL were mixed with 2.00 mL Anthrone reagent 0.1% w/v in concentrated sulphuric acid. Due to the enthalpy of mixing, the sample was heated to its boiling point. The boiling mixture was then cooled to room temperature. After 45 minutes the sample was vortexed and 200 μL of sample was analysed in a plate reader (Benchmark Platereader, Bio-Rad, Hercules, USA) at 630 nm. In every assay two 11 point calibration curves of the appropriate spray freeze dried powder in the appropriate medium was established. In each of the experiments the recovery was above 90%.

### Example 2

### Preparation of Spray Freeze Dried Powder of THC to Form an Inulin Glass

To produce a spray freeze dried powder, aqueous inulin solutions of various concentrations and a 10-mg/mL THC in TBA solution were prepared (Table I).

TABLE I
Composition of the different mixtures used to produce solid dispersions.

| | | After mixing | | | After spray |
|---|---|---|---|---|---|
| Before mixing | | inulin in | THC in | | freeze |
| Inulin in | THC in | water/ | water/ | solid | drying |
| water | TBA | TBA | TBA | material | Drug load |
| (mg/mL) | (mg/mL) | (mg/mL) | (mg/mL) | (mg/mL) | (% w/w) |
| 160 | 10.0 | 96.0 | 4.00 | 100 | 4.0 |
| 76.7 | 10.0 | 46.0 | 4.00 | 50.0 | 8.0 |
| 48.8 | 10.0 | 29.3 | 4.00 | 33.3 | 12 |
| 35.0 | 10.0 | 21.0 | 4.00 | 25.0 | 16 |
| 26.7 | 10.0 | 16.0 | 4.00 | 20.0 | 20 |
| 15.6 | 10.0 | 9.33 | 4.00 | 13.3 | 30 |

Subsequently these solutions were mixed at a volume ratio water/TBA of 6/4. The solution containing both THC and inulin was sprayed with the 0.5 mm nozzle of the Büchi 190 mini spray dryer (Büchi, Flawil, Switserland). The liquid feed rate was 10.5 mL/min and the atomising air flow was set at 400 Lₙ/h. The outlet of the nozzle was positioned about 10 cm above liquid nitrogen. Hot water was pumped through the jacket of the nozzle in order to avoid freezing of the solution inside the nozzle. The resulting suspension (frozen droplets of the solution in liquid nitrogen) was transferred into the freeze dryer (Christ, model Alpha 2-4 lyophilizer, Salm and Kipp, Breukelen, The Netherlands). Vacuum was applied as soon as all nitrogen was evaporated. During the first 24, hours the pressure was set at 0.220 mbar and the shelf temperature at −35° C. (condenser temperature −53° C.). During the second 24 hours, the shelf temperature was gradually raised to 20° C. while the pressure was decreased to 0.05 mbar. After removing the samples from the freeze drier, they were stored over silicagel in a vacuum desiccator at room temperature for at least 1 day.

As can be seen in table I, the drug load was varied by spray freeze drying solutions of various inulin concentrations while keeping the THC concentrations constant. When solid dispersions were prepared by freeze drying (for comparison) a previously described freeze drying procedure was followed (D. J. Van Drooge et al., Eur. J. Pharm. Sci. 2004, 21, 511-518). This procedure uses the same instrument settings as applied during drying of spray freeze dried material.

### Example 3

### Characteristics of Spray Freeze Dried THC Containing Powder

The spray freeze dried solid dispersions appeared as a white powder with a low bulk density ranging from about 20 to 85 mg/cm³ and a very high bulk porosity ranging from 94% to 99% depending on the total solid concentration in the solution. Furthermore, the powder easily swirled up, which is a first indication of its applicability for inhalation.

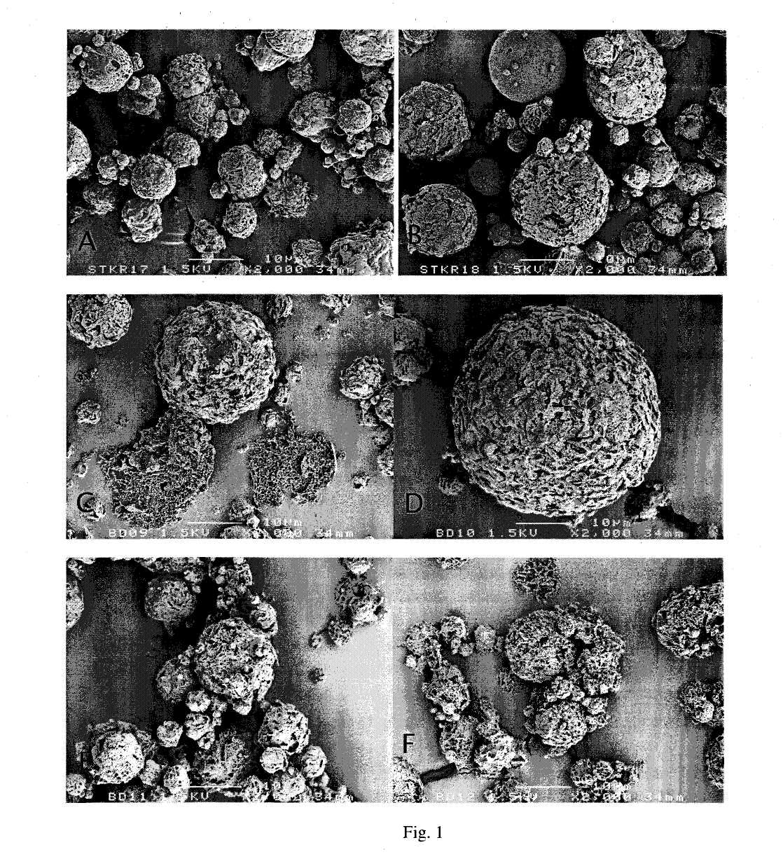

The SEM pictures of the different powders are shown in FIG. 1 (representative SEM pictures for drug loads of 4, 8, 12, 16, 20 and 30 wt-% designated as pictures A, B, C, D, E and F, respectively).

They showed a high porosity and a rough surface in all cases. The surface texture does not change when the drug load increased but somewhat more broken particles were observed at the highest drug load indicating high fragility.

Due to handling problems, the porosity of the spray freeze dried particles could not be measured directly. However, an estimation could be performed with larger spheres. The effect of solute concentration on droplet formation, freezing and particle size after drying was investigated. The results are depicted in Table II.

TABLE II
Size (relative to droplet size) and porosity of particles during spray
freezing process

| inulin conc. | | | | |
|---|---|---|---|---|
| (mg/mL) | 100 | 50.0 | 25.0 | 13.3 |
| droplet | 100 ± 0.2 | 100 ± 0.1 | 100 ± 0.5 | 100 ± 0.7 |
| size (%) | | | | |
| frozen droplet | 102 ± 5.1 | 104 ± 2.4 | 103 ± 2.1 | 104 ± 2.6 |
| size (%) | | | | |
| particle size | 84.1 ± 2.4 | 79.7 ± 2.8 | 78.2 ± 2.7 | 66.9 ± 3.0 |
| (%) | | | | |
| porosity of | 89.0 ± 0.24 | 93.6 ± 0.13 | 96.6 ± 0.09 | 97.1 ± 0.08 |
| particle (%) | | | | |
| density of | 169 ± 3.63 | 99.4 ± 2.06 | 52.6 ± 1.37 | 44.6 ± 1.26 |
| particle | | | | |
| (mg/cm³) | | | | |

The droplet sizes were 3.45 mm and independent of inulin concentration. After freezing a small increase in diameter was observed, indicating that a water/TBA solution containing inulin expands slightly upon freezing. The expansion was irrespective of inulin concentration. Furthermore, spray freeze drying of lower concentrated solutions yielded particles of higher porosities. However, after lyophilization of the frozen solution spheres, all particles were significantly smaller. During drying, particle diameters decreased to 84.1% of the droplet size for the most concentrated solution and even more (79.7-66.9%) for particles with lower inulin concentrations. This implies that particles prepared from low concentrated solutions shrink more during drying which is likely caused by their higher porosity and their consequently lower strength.

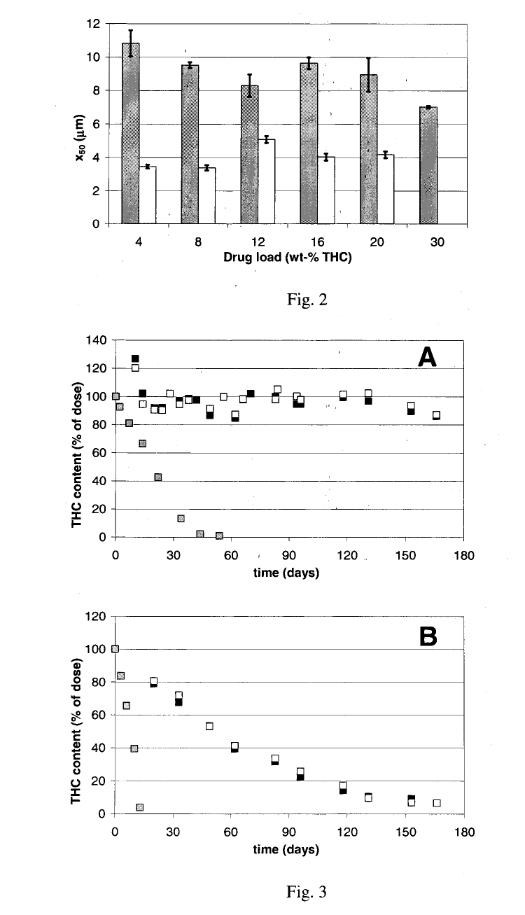

The geometric volume median diameter (x₅₀) of all THC containing powders was analysed with laser diffraction using two different dispersion methods. Firstly, the materials were dispersed with a RODOS disperser at a relatively low pressure of 0.5 bar in order to minimize the dispersion forces during the measurement. Secondly, the powders were dispersed by means of the test inhaler at 60 L/min for 3 seconds in order to measure the geometric particle size that actually leaves the inhaler. These test conditions correspond with the conditions during cascade impactor analysis. With RODOS measurements it was found that the geometric volume median diameter of all powders except for the 30 wt-% drug load more or less corresponded with estimations from SEM pictures (see FIG. 2: Median volume diameters of spray freeze dried powder, determined by laser diffraction with: RODOS dispersion at 0.5 bar (shaded columns) and with test inhaler dispersion at 60 L/min for 3 seconds (open columns) (error bars represent standard deviations, n≧4)).

At a drug load of 30 wt-%, the particle size appeared smaller. Apparently, due to their higher porosity, the particles are so fragile that the relatively low dispersion forces generated with the RODOS are already large enough to break up and de-agglomerate these powders. Much larger dispersion forces than are generated when the powders are dispersed with the test inhaler result in smaller particles (see FIG. 2). In this case, also less porous and less fragile particles (lower drug loads) are broken and de-agglomerated. Apparently, they are fragile enough to allow for disruption by the applied dispersion forces. Disruption may be advantageous to obtain high alveolar deposition during inhalation.

The BET specific surface areas of all powders ranged from about 70 to 110 m²/g. These very high specific surface areas are in accordance with previously reported data on spray freeze dried materials.

Finally, the powders were characterized by modulated differential scanning calorimetry (MDSC). In Table III, the glass transition temperatures (Tg's) of THC, amorphous inulin and the different solid dispersions are presented. As reported before, THC remains also above the Tg in the amorphous state since it resists crystallization. A Tg of 9.3° C. was observed for the pure THC. The inulin type used in this study has a Tg of 155° C. The results show that incorporation of THC in inulin glasses does not affect the Tg of inulin.

TABLE III
Glass transition temperatures found in solid dispersions with various
drug loads. All mixtures were prepared by spray freeze drying.

| drug load | | |
|---|---|---|
| (wt-%) | 1^{st} Tg (° C.) | 2^{nd} Tg (° C.) |
| 0 | — | 155 ± 0.6 |
| 4 | not observed | 156 ± 0.7 |
| 8 | not observed | 156 ± 0.6 |
| 12 | not observed | 155 ± 2.2 |
| 16 | not observed | 155 ± 1.7 |
| 20 | not observed | 156 ± 1.1 |
| 30 | 8.7 | 154 ± 1.4 |
| 100 | 9.3 ± 1.0 | — |

Only at the highest drug load could a Tg of THC be discerned. This indicates that at this drug load either THC molecules are homogeneously dispersed in the inulin (but form a percolating system) or that THC is no longer dispersed homogeneously throughout the inulin carrier. In either case, THC molecules are neighbouring resulting in a Tg of pure THC.

### Example 4

### Stability of THC in the Spray Freeze Dried Inuline Glass Powder as Function of Drug Load

The spray freeze dried solid dispersions containing THC, appearing as a white powder, showed no coloration in due time, which is an indication of effective stabilization of the labile THC by the inulin glass. The results of a more thorough investigation on the stabilization of THC are shown in FIG. 3 (THC content as a function of storage time in spray freeze dried powders with 4 and 8 wt-% THC and in pure THC samples. A: storage at 20° C./45% RH; shaded squares: pure THC, open squares: 4 wt-%, solid squares 8 wt-%. B: storage at 60° C./8% RH; shaded squares: pure THC, open squares: 4 wt-%; solid squares: 8 wt-%). The THC content in spray freeze dried powders containing 4 and 8 wt-% THC initially is plotted as a function of time. It was found that pure THC degrades completely within about 50 days when exposed to air of 20° C./45% RH. (see FIG. 3A) However, when it is incorporated in the glassy inulin matrix, about 80% of the THC could be recovered after 300 days. When the more stressful storage condition of 60° C./8% RH is chosen, pure THC degraded completely within 15 days. (see FIG. 3B) Again the glassy inulin matrix decelerated THC degradation. No differences in degradation rate were observed between the 4 and 8% drug load. Apparently, for both drug loads THC was effectively shielded from its environment by a matrix of inulin and thereby strongly stabilised.

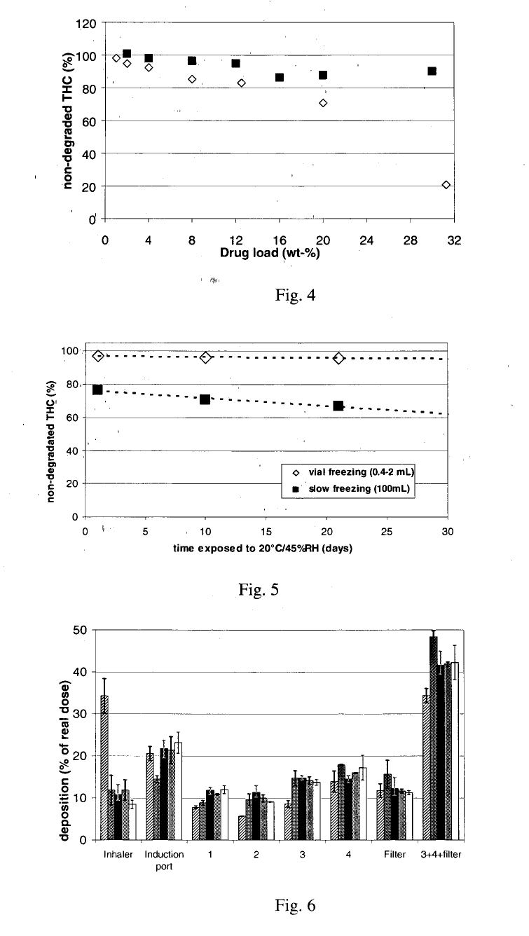

To investigate the effect of drug load on THC stabilisation in the solid dispersions in more detail, spray freeze dried powders of a wide range in drug loads were evaluated. To investigate the effect of freezing rate on THC stabilisation, solid, dispersions produced by freeze drying instead of spray freeze drying were subjected to a stability study. It appeared that at 20° C./45% RH all spray freeze dried powders effectively stabilised the THC even up to a drug load of 30 wt-% (see FIG. 4: Stability at 20° C./45% RH of THC in solid dispersions as a function of drug load. Given are the recoveries of THC (Black squares: spray freeze dried batches after 3.5 months; white diamonds: freeze dried material after 1.5 months, standard deviations all ≦15%). All spray freeze dried powders contained over 85% of the original THC content after storage for 3.5 months. When freeze dried cakes were exposed to same environment, significantly more THC was degraded even though the storage was only 1.5 months. Especially at high drug loads spray freeze drying yields substantially better stabilised material. It can be concluded that spray freeze drying is the optimal process for the production of solid dispersions, not only because particles are easily obtained but also because THC is strongly stabilized for all drug loads evaluated.

### Example 5

### Effect of Batch Size/Freezing Rate on Stability of Freeze Dried THC in Inulin

100 mL of solution containing inulin (type TEX!803, degree of polymerization 23) and THC dissolved in a mixture of water and TBA was frozen using liquid nitrogen. It took several minutes to completely freeze 100 mL of such a solution. Furthermore, small vials containing 0.4 mL or 2 mL of the same solution were frozen. After lyophilization solid dispersions were obtained with a theoretical drug load of 4%. Both batches were put in a vacuum desiccator for one day. The stability of THC in the slowly cooled batch was very limited, because as soon as this material was transferred from the freeze dryer to the vacuum desiccator, it turned purple indicating THC degradation. To test the long term stability of THC both batches were exposed to 20° C. and 45% Relative Humidity (RH). The results are depicted in FIG. 5: Effect of batch size on THC stability.

The immediate degradation of the slow freezing batch appeared to be large (about 22%). Furthermore, the long term stability was poor compared to material obtained by vial freezing. It can therefore be concluded that slow cooling results in a fraction of THC that is not stabilized at all and another fraction poorly stabilized, whereas vial freezing yields material with improved stability.

### Example 6

### In Vitro Deposition Behaviour of the Spray Freeze Dried THC Containing Powders

The geometric particle sizes, reported as the volume median diameter in the shaded bars in FIG. 2, indicated that the particles produced with spray freeze drying are rather large for an application in pulmonary drug delivery. Generally particles between 1 and 5 μm having a density of approximately 1 mg/cm³ are considered suitable for inhalation. After dispersion with the inhaler adapter, the geometric particle size of the powders measured with laser diffraction was about this size. However, the size limits refer to the aerodynamic diameter dₐₑᵣₒ, which is determined by the geometric diameter d_{geo}, the density of the particle ρ_{P} (estimations are given in table II), and the reference density ρ_{T} (the density of water taken as 1 g/cm³) The shape factor χ equals 1 for spherical particles and is larger than 1 for non-spherical particles. The aerodynamic diameter can be calculated according to the following equation.

$${d}_{aero} = {d}_{geo} \cdot \sqrt{\frac{{ρ}_{p}}{{ρ}_{r} \cdot χ}}$$

Since the particles in this study are extremely porous, i.e. ρ_{P} is very small, the aerodynamic diameter will be substantially smaller than the geometric diameter. When the particles are assumed to be spherical, the aerodynamic diameter will be approximately 40-20% of the geometrical diameter depending on the porosity and density of the particles. Therefore, it was interesting to subject the powders to cascade impactor analysis, because the results are governed by the aerodynamic diameter. Moreover, the outcome of cascade impactor analysis is considered to be predictive regarding the suitability for inhalation in vivo.

The air classifier type inhaler was used in the cascade impactor analysis because laser diffraction analysis showed small particles leaving the inhaler, caused by the strong dispersion forces typical for this type of inhaler (A. H. de Boer et al., Int. J. Pharm. 2003, 260, 187-200).

As can be seen in FIG. 6 (Cascade impactor results obtained with spray freeze dried powders having different drug loads. (cross hatched=4% THC, dotted=8% THC; black=12% THC, grey=16% THC, white=20% THC) (duplicate of two independently produced batches, error bars indicate highest and lowest value)), all powders showed high fine particle fractions. The fine particle fraction (FPF), here defined as the sum of the 3^{rd}, 4^{th} and the filter stage relative to the total dose, was very high for all powders. This implies that all powders showed excellent inhalation behaviour since the FPF is assumed to represent deep (peripheral) lung deposition during in vivo inhalation. All powders showed similar inhalation behaviour except for the powder with 4% drug load. For unknown reasons, this powder showed a high retention in the inhaler and an FPF of only 35%. However, all other materials showed less inhaler retention and a fine particle fraction of 40-50%. These results indicate that spray freeze dried powders in combination with an air classifier based inhaler is very promising for pulmonary delivery. Moreover, these in vitro inhalation simulations were performed with unformulated material: only spray freeze dried powder was used without any additional excipients or formulation techniques that could further improve the aerosolisation behaviour.

### Example 7

### Effect of Batch Size/Freezing Rate on Mode of Incorporation of Diazepam

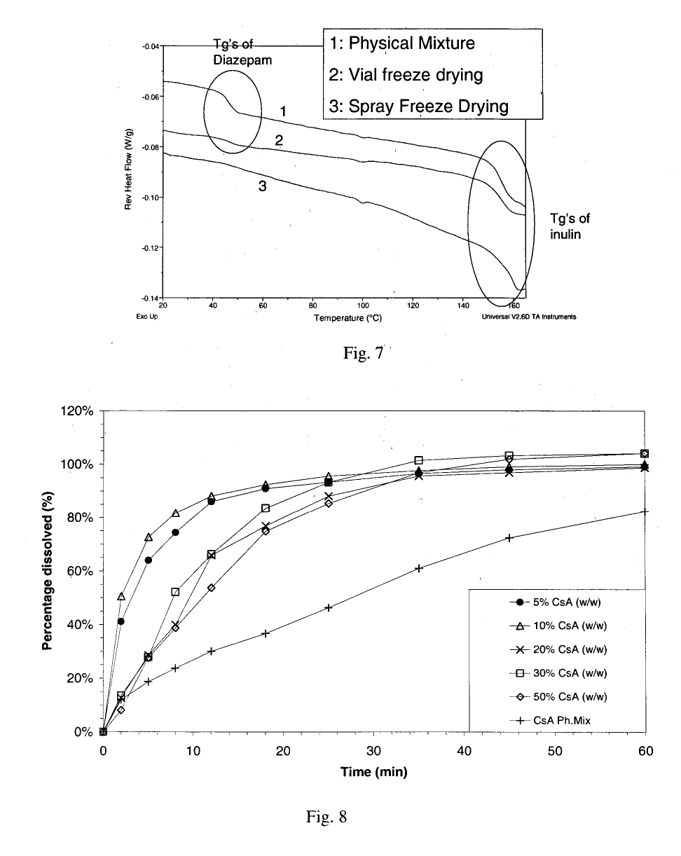

To investigate the effect of freezing rate on the mode of incorporation, the lipophilic model drug diazepam was incorporated in inulin (type TEX!803) by means of vial freeze drying (volumes of 2 ml in a vial were frozen) and spray freeze drying. When phase separation occurs during freezing, each phase in the amorphous solid dispersion should exhibit a glass transition temperature (Tg). Differential Scanning Calorimetry (DSC) was used to measure the number of Tg's. In the thermograms obtained from the DSC measurement, solid dispersions with high drug loads (35 wt-%) were compared with a physical mixture of amorphous diazepam and amorphous inulin. The results are depicted in FIG. 7 (Thermograms of solid dispersions and physical mixture containing diazepam and inulin).

In the physical mixture (trace 1) two Tg's could be discerned. In the vial freeze dried solid dispersion two Tg's were also discerned, however the Tg of diazepam was less pronounced, which indicates that phase separation is only partial. However, when a solid dispersion was produced by spray freeze drying, only one Tg could be discerned. It can therefore be concluded that phase separation during freezing between inulin and lipophilic drug can be prevented by fast cooling (small amounts of liquid).

### Example 8

### Preparation of Spray Freeze Dried Cyclosporine Containing Powders With Different Drugloads

5 batches of different composition were prepared by dissolving Cyclosporin A (CsA) in tert-butanol (TBA) and inulin (DP23) in demineralised water. The concentrations of CsA in TBA and inulin in water were adjusted to achieve a 5%, 10%, 20%, 30% and 50% (w/w CsA/inulin) drugload with a total concentration of 65 mg/ml when the TBA/CsA solution was mixed with the water/inulin solution in a ratio of 40% (v/v) TBA/CsA and 60% (v/v) water/inulin. A batch of pure CsA was also produced in a TBA/water solution, albeit in a lower total concentration of 3 mg/ml. The partial concentration of CsA in TBA used in the pure CsA batch was comparable to the partial concentration of a 5% (w/w) formulation. After mixing the TBA/CsA solution with,the water/inulin solution in a 40:60 (v/v) ratio the resulting solution was sprayed over a bowl of liquid nitrogen. The solution was sprayed using a two-fluid nozzle with an orifice of 0.5 mm, a fluid flow rate of 3 ml/min and an atomizing air flow rate of 500 l/h. Upon completion of the spraying procedure the bowl of liquid nitrogen containing frozen droplets of TBA/water was transferred to a lyophilizer. After most of the liquid nitrogen was evaporated a lyophilizing procedure was started. To sublimate excess solvent the sample was exposed to a shelve temperature −35° C. and a pressure of 0.220 mbar. After 24 hours the temperature and pressure was incrementally increased over a 3 hour period to 20° C. and 0.05 mbar in order to evaporate absorbed solvent in the glassy formulations. Subsequently all produced formulations were stored in a vacuum exsiccator

Dissolution experiments were carried out as described in Example 1b. All formulations were weighed in the basket to an amount of 30 mg CsA, ie. in all dissolution experiments 30 mg CsA was dissolved. The results of the dissolution experiments are depicted in FIG. 8. For the dissolution of pure CsA 30 mg was weighed and 70 mg pure inulin (also spray freeze dried) was added. This sample is indicated in FIG. 8 as “physical mixture (Ph.mix)”. From the results it can be concluded that incorporation of CsA into inulin (DP23) increases the rate of dissolution up to a drugload of 50% (w/w) compared to not-incorporated CsA (CsA Ph.Mix). Although the 5 and 10% (w/w) formulations dissolve faster than the 20, 30 and 50% the effect is clearly visible even at the latter drugloads.

What is claimed is:

1. A method for the preparation of a pharmaceutical composition comprising a lipophilic compound and a glass of a sugar, a sugar alcohol, a mixture of sugars or a mixture of sugars alcohols, wherein the lipophilic compound is incorporated in the glass, comprising the steps of:
(a) dissolving said lipophilic compound in an organic solvent that is miscible with water to form a first solution;
(b) dissolving said sugar, sugar alcohol, mixture of sugars or mixture of sugar alcohols in water to form a second solution;
(c) mixing the first and second solutions to obtain a substantially homogeneous mixture; and
(d) spray freeze drying said substantially homogeneous mixture, prior to phase separation, to form said pharmaceutical composition.

2. The method of claim 1, wherein said steps (c) and (d) are performed in a continuous or semi-continuous way.

3. The method of claim 2, wherein said sugar or mixture of sugars comprises a non-reducing sugar or a mixture of non-reducing sugars.

4. The method of claim 3, wherein said sugar or mixture of sugars is a fructane or a mixture of fructanes.

5. The method of claim 4, wherein said fructane or mixture of fructanes is inulin or a mixture of inulins, preferably inulin with a DP of not less than about 6 or a mixtures of inulins wherein each inulin has a DP not less than about 6.

6. The method of claim 1, wherein said organic solvent comprises 1,4-dioxane or a C₁-C₆ alcohol.

7. The method of claim 6, wherein said organic solvent comprises a C₂-C₄ alcohol.

8. The method of claim 1, wherein said lipophilic compound comprises a natural cannabinoid compound.

9. The method of claim 8, wherein said natural cannabinoid compound is Δ⁹-tetrahydrocannabinol.

10. The method of claims 1, wherein said lipophilic compound comprises diazepam.

11. The method of claim 1, wherein said lipophilic compound comprises cyclosporin A.

12. A pharmaceutical composition prepared according to the process of any one of claims 1 or 8-11.

13. A pharmaceutical composition comprising a lipophilic compound and a glass of a sugar, a sugar alcohol, a mixture of sugars or a mixture of sugar alcohols, obtained by spray freeze drying, wherein the lipohilic compound is incorporated in the sugar glass, and wherein the composition comprises spherical particles having a mean geometric particle size of about 6 to about 5000 μm.

14. The pharmaceutical composition of claim 13, wherein the composition comprises spherical particles having a mean aerodynamic particle size of about 1 to about 5 μm.

15. The pharmaceutical composition of either of claim 14, wherein the porosity of said composition is about 80% or greater.

16. The pharmaceutical composition of claim 15, wherein said lipophilic compound does not form of a guest-host complex with said sugar, sugar alcohol, mixture of sugars or mixture of sugar alcohols.

17. The pharmaceutical composition of claim 16, wherein said sugar or mixture of sugars is a non-reducing sugar or a mixture of non-reducing sugars.

18. The pharmaceutical composition according to 13, wherein said sugar glass has a glass transition temperature of above 50° C. at normal environmental conditions.

19. The pharmaceutical composition of claims 18, wherein said sugar or mixture of sugars is a fructane or a mixture of fructanes.

20. The pharmaceutical composition of claim 19, wherein said fructane or mixture of fructanes is inulin or a mixture of inulins.

21. The pharmaceutical composition of claim 19, wherein said fructane or mixture of fructanes is inulin with a DP of at least about 6, or a mixtures of inulins wherein each inulin in said mixture has a DP of at least about n 6.

22. The pharmaceutical composition of claim 19, wherein said inulin or each inulin in said mixture has a DP of about 10 to about 30,

23. The pharmaceutical composition of claim 19, wherein said inulin or each inulin in said mixture has a DP of about 15 to about 25.

24. The pharmaceutical composition of claim 23, wherein said lipophilic compound is a natural cannabinoid compound.

25. The pharmaceutical composition of claim 24, wherein said natural cannabinoid compound comprises Δ⁹-tetrahydrocannabinol.

26. The pharmaceutical composition of claim 23, wherein said lipophilic compound comprises diazepam.

27. The pharmaceutical composition of claim 26, wherein said lipophilic compound comprises cyclosporin A.
